(19) United States
(12) Patent Application Publication
(10) Pub. No.: US 2008/0072710 A1
(43) Pub. Date: Mar. 27, 2008

(54) Novelty fin key and method of using same

(75) Inventor: Brett D. Ritter, Del Mar, CA (US)

Correspondence Address: JERRY RICHARD POTTS, 3248 VIA RIBERA, ESCONDIDO, CA, 92029, US

(73) Assignee: South Cone, Inc. dba REEF, San Diego, CA (US)

(21) Appl. No.: 11/528,775

(22) Filed: Sep. 27, 2006

(51) Int. Cl. B67B 7/16

(52) U.S. Cl. 81/3.55

(57) ABSTRACT

A novelty construction includes a fin key for locking and unlocking a water device fin and a sealing cap opener disposed on the fin key for prying open a sealing cap of a sealed container, wherein the fin key and the sealing cap opener are partially encased with a finger gripping construction that facilitates rotational movement of the fin key and lever-like prying motion of the sealing cap opener.

### BACKGROUND OF THE INVENTION

### Background of Prior Art

This invention relates generally to novelty items and more particularly to a novelty item in the form of a combination fin key and bottle cap opener and a novel method of using the combination fin key and bottle cap opener for locking and unlocking water device locks and uncapping sealed bottles.

### BRIEF SUMMARY OF THE INVENTION

A new and improved novelty item construction includes a fin key for locking and unlocking a water device fin and a sealing cap opener for prying open a sealing cap of a sealed container, such as the cap from a capped bottle. The novelty construction includes a straight leg fin key member having an external hex-shaped and a tappered wing member integrally connected thereto and extending outwardly therefrom at an acute angle of about θ degrees. The straight leg member and the tappered wing member are partially encased within a finger gripping construction that facilitates rotational movement of the fin key and lever-like prying motion of the tappered sealing cap opener.

### BRIEF DESCRIPTION OF THE DRAWINGS

The above-mentioned features and steps of the invention and the manner of attaining them will become apparent, and the invention itself will be best understood by reference to the following description of the embodiments of the invention in conjunction with the accompanying drawings wherein:

FIG. 1 is a right side elevational view of a novelty item, which is constructed in accordance with the present invention; construction

FIG. 2 is a sectional view of the novelty item of FIG. 1, taken substantially along line 2-2;

FIG. 3 is a sectional view of the novelty item of FIG. 1, taken substantially along line 3-3;

FIG. 4 is a sectional view of the novelty item of FIG. 1, taken substantially along line 4-4;

FIG. 5 is a sectional view of the novelty item of FIG. 1, taken substantially along line 5-5;

FIG. 6 is a front elevational view of the novelty item of FIG. 1;

FIG. 7 is a sectional view of the novelty item of FIG. 6, taken substantially along line 7-7;

FIG. 8 is a side elevational view of a body member of the novelty item of FIG.

FIG. 9 is a sectional view of the body member of FIG. 8, taken substantially along line 9-9;

FIG. 10 is a sectional view of the body member of FIG. 8, taken substantially along line 10-10;

FIG. 11 is a sectional view of the body member of FIG. 8, taken substantially along line 11-11;

FIG. 12 is a left-side elevational view of the novelty item of FIG. 1;

FIG. 13 is a pictorial view of the novelty item of FIG. 1, illustrating the item being used to pry open a sealed bottle; and

FIG. 14A-B is another pictorial view of the novelty item of FIG. 1, illustrating the item being used to engage the locking pin of fin lock.

### DETAILED DESCRIPTION OF THE PREFERRED EMBODIMENTS OF THE INVENTION

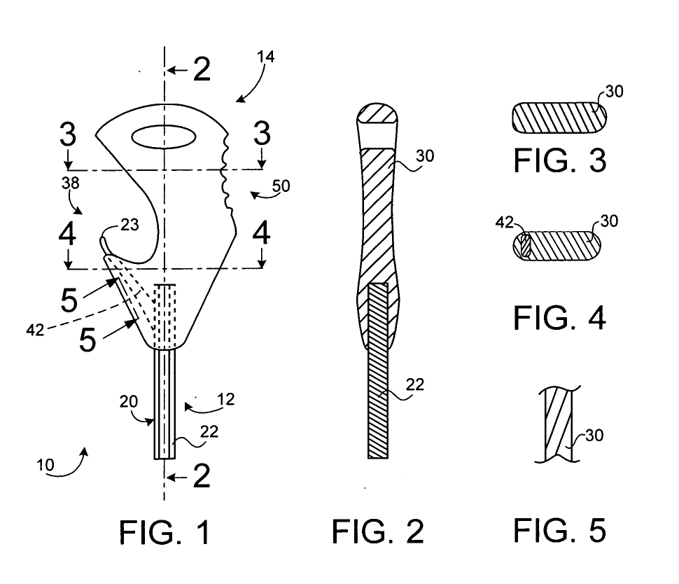

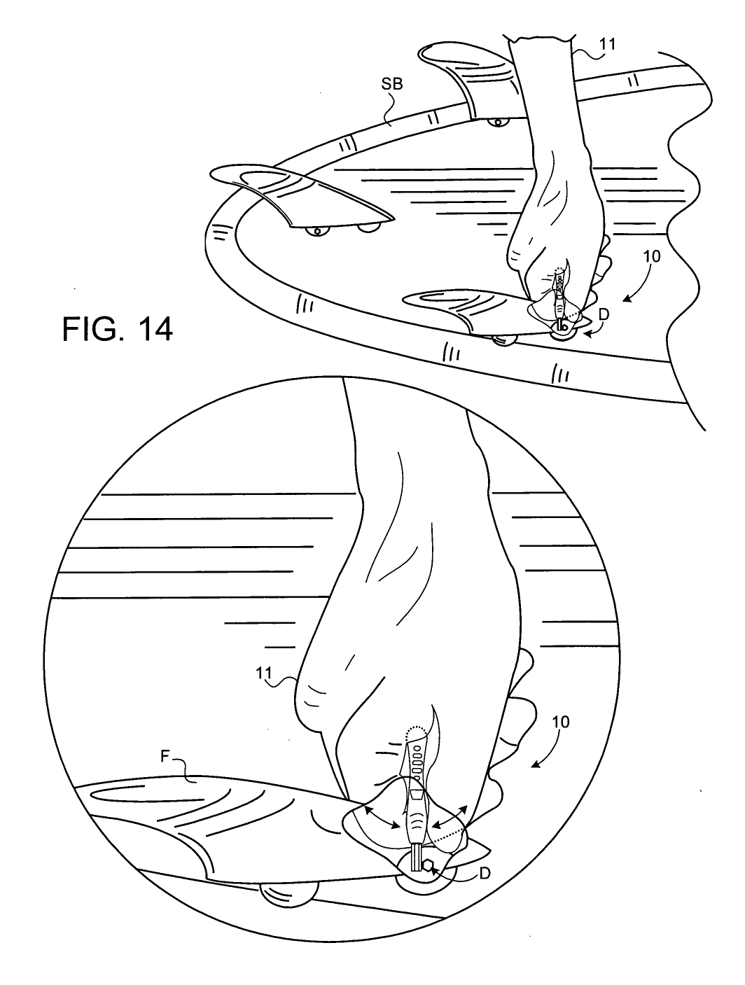

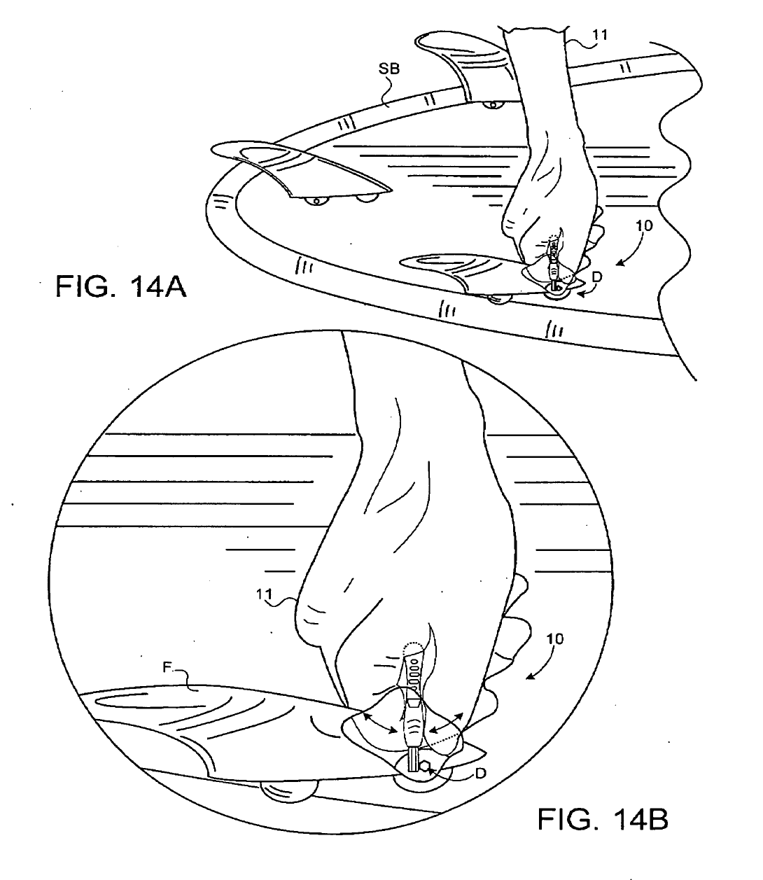

Referring now to the drawings and more particularly to FIGS. 1-14 there is shown an illustrative preferred embodiment of a novelty construction or item 10, which is constructed in accordance with the present invention. The novelty item or novelty construction 10 when used in accordance with a novel method of using the novelty item 10 enables a user 11 to easily and conveniently open a bottle B having sealing cap C (FIG. 13) as well as lock or unlock a fin lock, such as the fin lock D as best seen in FIG. 14.

Considering now the novelty item 10 in greater detail with reference to FIGS. 1 and 8-12, the novelty item 10 generally includes a first structure 12 and a second structure 14, where the first structure 12, is partially encased within the second structure 14 to allow a user to manipulate the first structure 12 in one of two and completely different tool manipulation modes of operation as will be explained hereinafter in greater detail.

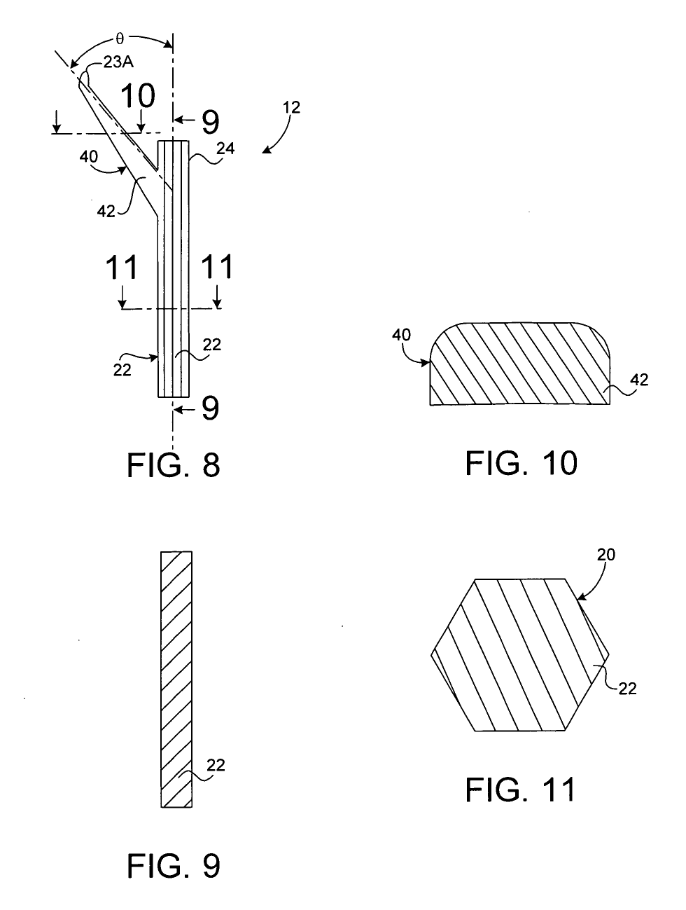

As best seen in FIG. 8, the first structure 12 generally includes a first tool or fin key 20 for locking and unlocking a water device fin, such as the fin F of a surfboard SB, and a second tool or sealing cap opener 40 for prying open a sealing cap of a sealed container, such as the cap C from the capped bottle B. The second structure 14, as will be explained hereinafter in greater detail, allows a user to manipulate the tool structure 12 in a first mode operation consisting of a rotating action for locking or unlocking a fin lock, such as the fin lock D, and in a second mode of operation consisting of a lifting action for prying open a bottle cap C from its associated sealed bottle B.

Although in the preferred embodiment of the present invention the first tool 20 is described as a fin key, it should be understood by those skilled in the art that the first tool 20 can function in combination with the second structure 14 as a conventional allen wrench. Therefore, there is no intention of limiting the scope of the first tool 20 to that of a fin key as it may function more broadly as an alien wrench.

Considering now the first structure 12 in greater detail with reference to FIGS. 8-11, the first tool 20 generally includes a straight leg member 22 having an external hex-shaped, as best seen in FIG. 11, and the second tool 40 which generally includes another straight leg member 42 having a generally rectangular shape as best seen in FIG. 10. The another straight leg member 42 is integrally connected to the straight leg member 22 and extends outwardly therefrom at an acute angle of about θ degrees. The angle θ is between about 5 degrees and about 85 degrees. A more preferred angle θ is between about 20 degrees and about 70 degrees, while the most preferred angle θ is about 30 degrees.

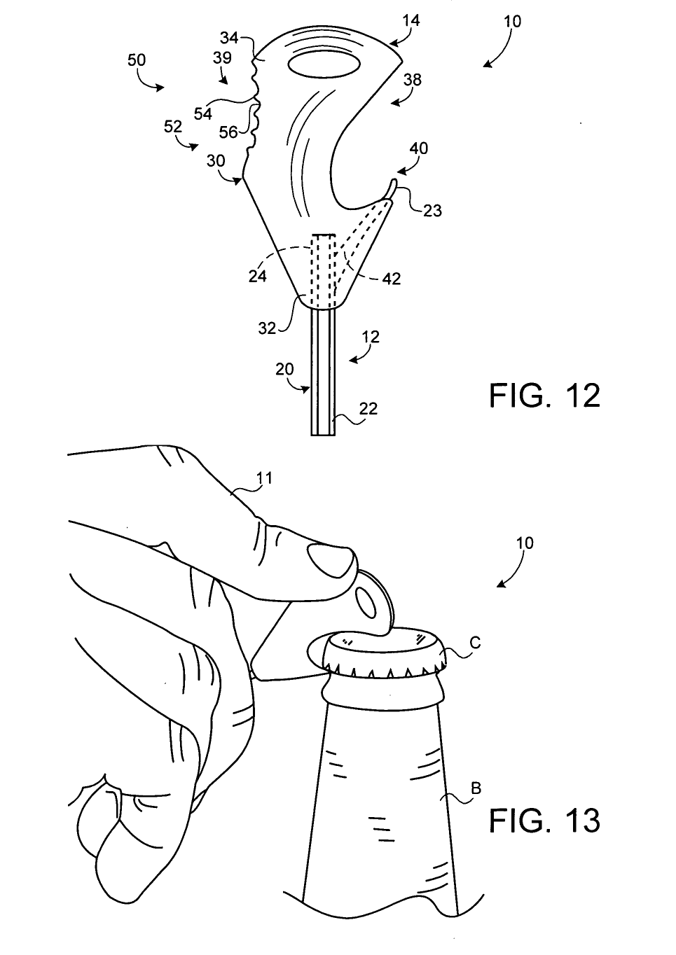

The straight leg member 42, as best seen in FIG. 8 is tappered over its longitudinal length, having its most narrow construction at its distal end 43, which is located furthest from the straight leg member 22. Both the straight leg member 22 and the tappered straight leg member 42 are partially encased within the second structure 14, which is constructed as a finger gripping member or construction that facilitates rotational movement of the fin key member 20 and lever-like prying motion of the tappered sealing cap opener 40. More particularly as best seen in FIG. 12, only a tip portion of the opener 40 is encased within the second structure 14, while most of the fin key member 20 is encased within the second structure 14. These are important features of the present invention, as the greater the distance is from a distal end 22 of the fin key 20 is from the second structure 14, the easier it is for the user 11 to point and direct the distal end 22 into a fin key lock, such as the fin key lock D. Similarly, by only leaving the distal end 23 of the opener 40 free of the second structure, the easier it is for the user 11 to position the tip 23 of the opener 40 under the lip portion of a bottle cap C, as best seen in FIG. 13.

Considering now the finger gripping construction 14 in greater detail with reference to FIGS. 1 and 12, the finger gripping construction 14 has a tappered oval-like or tear drop shaped body 30 with a narrow distal or lower end, indicated generally at 32, and a broad proximate or wide end, indicated generally at 34. An oval or first cut out 36 is disposed in the wide end of the body 30. The cut out 36 is dimensioned for receiving therein a key-chain (not shown) which in turn, allows the tool 10 to be attached to the key-chain of the user 11 for easy access and use.

For the purpose of permitting the first structure 12 and the second structure 14 to cooperate with one another to function as the opener 40, the body 30 includes a generally U-shaped or first cut-out 38 and a disc-shaped or second cut out 39. The disc-shaped cutout 39 is disposed on one side of the body 30, while the U-shaped cut-out 38, is disposed on an opposite side of the body 30. As best seen in FIG. 12, the cut-out 38 is also disposed adjacent to the distal end 23 of the straight leg member 42.

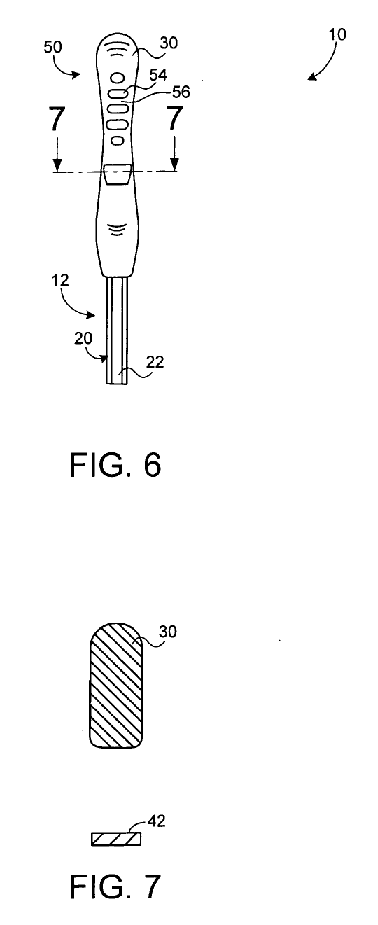

For finger support purposes, the second structure 14 also includes a rough finger support area, indicated generally at 50. The finger support area 50 is disposed on the opposite side of the body 30 from cutout 38 and is composed of a series 52 of spaced apart ridges and valleys, such as a ridge 54 and a valley 56. The series 52 of spaced apart ridges and valleys, provide a rough surface area on the otherwise smooth body 30 so as to prevent the finger of a user present in this area from slipping from the rough support when the tool 10 is utilized in either of its modes of operation, such as for prying or lifting as best seen in FIG. 13, or rotating in a clockwise or counter clockwise direction as best seen in FIG. 14. FIG. 6 illustrates the body 30 and the spacing of the ridges and valleys. FIG. 7 is a cross section of the tool 10 taken along line 7-7 of FIG. 6, illustrating the body 30 and the straight leg member 42.

Considering now the cut-out 38 in greater detail with reference to FIGS. 1 and 12, the generally U-shaped cut-out 38 has a sufficient overall length and depth for receiving therein a conventional bottle cap C, such that the bottle cap C, so that the cap C may be wedged within the cutout 38 against the body 30 of the tool 10 and between the distal end 23 of the second tool 40. In this regard, the cut out 38 and the distal end 23 of the straight leg member 42 form a hook like configuration that can grasp the top of a sealing cap, such as the cap C.

As best seen in FIGS. 1 and 13 the end portion 23 protrudes from the body 30 sufficient distance to allow the end portion 23 to engage a lip portion of the cap C for lifting away or opening purposes. The distance the end portion 23 protudes from the body 30 is also a sufficient distance to prevent the lip of the cap C from engaging the body 30. To facilitate such an lifting and grasping action, the distal end portion of the cap opener 40 is configured to extend the U-shape of the cut-out 38 a slight distance away from the body member 30. In this regard, the distal end of the opener 40 can be configured as a straight extenstion member 23 (FIGS. 1 and 12) or in a hook-like extension configuration 23A (FIG. 8).

The tappered construction of the straight leg member 42 narrows from where the straight leg member 42 is integrally attached to the straight leg member 22, narrowing to its smallest overall cross-section area at about the tip area 23 of the straight leg member 42. This structure provides a sufficient cross section area for the distal end portion 23 of the straight leg member 42 to slip under the lip of the cap C for cap engagement and cap prying purposes. The strength of the opener 40 is derived by constructing the straight leg member 42 in a common plane as that of the lower portion of the body 30 as best seen in FIG. 7.

Considering now the novel method of using the unique combination fin key cap opener tool 10 in greater detail with reference to FIGS. 13-14, in use, a user grabs the finger gripping construction 14 between a set of his or her fingers as best seen in FIG. 13, resting one finger on the rough area 50, while pinching the body 30 between the thumb and another finger of the user so the user may guide the broad end 34 of the tool 10 toward the bottle B so that the cap C can be captured within the cutout 38. As the cap C is brought into capturing engagement within the cutout 38, the user 11 directs the distal end 23 (or 23A) of the tapper cap opener 40 under the lip of the cap C. When the cap C is captured in this position with the distal end 23 of the opener 40 under the cap C, the user 11 presses down on the rough area 50, while simultaneously lifting the tool 10 within his or her pinched fingers upwardly or away from the cap C a sufficient distance to permit the opener 40 to dislodge or uncap the cap C from the bottle B.

In a similar manner, when the user desires to use the fin key member 12 to lock or unlock a surfboard fin from the surfboard SB, as best seen in FIG. 14, the user 11 grabs the finger gripping construction 30 between a set of his or her fingers as best seen in FIG. 14, resting one finger on the rough area 50, while pinching the body 30 between the thumb and another finger of the user so the user may guide the narrow end 32 of the tool 10 toward a surfboard surface and the lock D of its associated fin F so the straight leg member 16 can be guided into the lock D. When the straight leg member 22 is captured within the lock D, the user rotates the tool 10 in either a clockwise or counter-clockwise direction (as best seen in FIG. 14) depending upon whether the lock D is to be locked or unlocked. In this regard, the user 11 continues to rotate the tool 10 about its longitudinal axis a sufficient number of times to achieve the desired locking or unlocking effect.

Considering now the tool 10 in still greater detail with reference to FIGS. 1-5, the first structure 12 has a unitary construction in a generally Y-shaped configuration having one lower leg member 22 and two upper leg members 24 and 42 respectively. In this Y-shaped configuration, one of the upper legs 42 is substantially longer than the other upper leg 24. Also in this Y-shaped configuration, one of the upper legs 24 is substantially co-aligned with the lower leg member 22, while the other upper leg 42 is offset from being in co-alignment with the lower leg 22. This is an important feature of the present invention where the second structure 14 reinforces the first structure 12, and where in the first structure 12, the lower leg 22 and the upper leg 24 contain the same hex shape in cross section permitting them to cooperate with one another to help facilitate forming the first tool structure 20. Similarly second structure 14 cooperates with the first structure 12 permitting the lower leg 22 and the upper leg 24 to cooperate with one another to support the offset upper leg 42, so the three legs 22,24, and 42 in cooperation with the body 30 help facilitate forming the cap opener 40.

In summary then, the following important features of the tool 10 should be noted:

1. The first structure 12 and the second structure 14 cooperate with one another to form the fin key 20 and the cap opener 40, where the fin key 20 includes the straight leg member 22 and the straight leg member 24, where each has a six-sided configuration. FIG. 9, illustrates the co-alignment of the straight leg member 22 and the the straight leg member 24 by showing them in cross section taken substantially along line 9-9 of FIG. 8, while FIG. 11 illustrates their common six-sided structure in cross section taken substantially along line 11-11 of FIG. 8.

2. The first structure the second structure 14 cooperate with one another to also form the cap opener 40, where the cap opener 40 includes the tappered leg member 42, supported by the co-aligned straight leg members 22 and 24 respectively. With respect to the tappered leg member 42 it should be noted that it has a generally rectangular configuration, where in FIG. 10 the tappered leg member 42 is shown in cross section taken along line 10-10 of FIG. 8.

3. In FIG. 8, it can be seen that the tappered leg member 42 is broad at its proximal end and narrow at its distal end 23. It can also be seen that the proximal end of the tappered leg member 42 is integrally attached substantially between the straight leg member 22 and the straight leg member 24 to provide the cap opener with its maximum tensile strength at the joint where leg 42 is offset from legs 22 and 24 by about 30 degrees.

Considering now the second structure 14 in still greater detail, the second structure 14 has a greater thickness at its lower end to provide a maximum support for the first tool 12. The lower end of the second structure 14 is also tappered as best seen in FIG. 2. In this regard, FIG. 2 illustrates the tool 10 in cross section taken substantially along line 2-2 of FIG. 1.

FIGS. 3 and 4 illustrate the tool 10 in cross section taken substantially along line 3-3 of FIG. 1 and line 4-4 of FIG. 1 respectively. FIG. 5 is a cross section of the body 30 structure taken along line 5-5 of FIG. 1. The body 30 is composed of polyurethane which provides a strong rigid encasement for the structure 12. Also, FIG. 2 illustrates that the body member 30 has a general hour-glass structure having an upper finger and thumb engaging portion and a lower tool supporting portion as best seen in FIG. 1. The body member 30 has a longitudinal axis shown along line 2-2 of FIG. 1, which has sufficient longitudinal dimension to facilitate rotating movement of the fin key about this longitudinal axis to lock and unlock a water device fin key, such as the fin key D. The body member 30 also has a sufficient thickness to support from below a thumb of a user to facilitate a lever-like prying action along the longitudinal axis of the body member 30 for sealing cap removing purposes.

In the preferred embodiment of the present invention the body member 30 is composed of an opaque polyurthane material. However, the body member may be composed of other rigid materials and the polyurthane material may be a clear or transparent polyurthane material so a user may enjoy viewing the unique the shape of the first structure 12.

While the invention has been particularly shown and described with reference to the preferred embodiments thereof, it will be understood by those skilled in the art that various changes and modifications in form and details may be made therein without departing from the true spirit and scope of the invention.

I claim:

1. A novelty construction, comprising:
a fin key for locking and unlocking a water device fin; and
an sealing cap opener disposed on said fin key;
wherein the fin key and the sealing cap opener are partially encased with a finger gripping construction that facilitates rotational movement of the fin key and lever-like prying motion of the sealing cap opener.

2. A method of using a novelty item, comprising the steps of
providing a fin key construction having disposed thereon a sealing cap opener;
engaging a sealing cap of a sealed bottle with said sealing cap opener; and
moving the sealed bottle away from said sealing cap opener with sufficient force to cause the opener to remove the sealing cap.

3. A novelty item, comprising:
a body member having a straight leg portion for locking and unlocking a water device fin member and another straight leg portion for uncapping a sealing cap; and
another body member for encasing a portion of said straight leg portion to facilitate its rotational manipulation to lock and unlock said water device fin member and for encasing a portion of said another straight leg portion to facilitate its lifting manipulation to uncap said sealing cap.

4. A novelty item, comprising:
a first structure for facilitating the combination of locking and unlocking a water device fin member and a capped container; and
a second structure for partially encapsulating said first structure to facilitate finger manipulation of said first structure to lock, unlock water device fin members and open capped containers.

5. The novelty item according to claim 4, wherein said first structure is a generally Y-shaped structure.

6. The novelty item according to claim 5, wherein said Y-shaped structure includes:
a straight leg member having a six-sided configuration; and
another straight leg member having a generally rectangular configuration.

7. The novelty item according to claim 6, wherein said another straight leg member is integrally connected to said first straight leg member and is disposed at about an angle θ relative to said first straight leg member.

8. The novelty item according to claim 7, wherein said angle θ is preferably between about 5 degrees and about 85 degrees.

9. The novelty item according to claim 8, wherein a more preferred angle θ is between about 20 degrees and about 70 degrees.

10. The novelty item according to claim 9, wherein the most preferred angle θ is about 30 degrees.

11. The novelty construction according to claim 1, wherein said fin key and said sealing cap opener are partially enclosed in polyurethane encasement.

12. The novelty construction according to claim 11, wherein said polyurethane encasement has a longitudinal axis and a sufficient longitudinal dimension to facilitate rotating movement of said fin key about the longitudinal axis to lock and unlock said water device fin key.

13. The novelty construction according to claim 12, wherein said polyurethane encasement has a sufficient thickness to support from below a thumb of a user to facilitate a lever-like prying action along the longitudinal axis of said encasement for sealing cap removing purposes.

14. The novelty item according to claim 3, wherein said another body member has a general hour-glass structure having an upper finger and thumb engaging portion and a lower tool supporting portion;
wherein said lower tool supporting portion partially encases a top portion of said straight leg portion and all but a distal end portion of said another straight leg portion.

15. The novelty item according to claim 14, wherein said upper finger and thumb engaging portion includes a cutout for receiving therein the sealing cap end of a sealed container.

16. The novelty item according to claim 15, wherein said upper finger and thumb engaging portion includes another cutout for receiving therein a key-chain.

17. The novelty item according to claim 15, wherein said upper finger and thumb engaging portion includes a thumb tab having a series of peaks and valleys.

18. The novelty item according to claim 17, wherein said thumb tab and said cutout are disposed opposing one another to facilitate a lever like action for prying open a sealing cap.

19. The novelty item according to claim 18, wherein said another cut out and said body member are disposed opposing one another; and
wherein said cutout is generally U-shaped.

20. A method of using a novelty item, comprising the steps of
providing a sealing cap opener construction having a longitudinal axis with a fin key disposed thereon;
engaging a fin lock of a water device with said fin key; and
rotating said sealing cap opener construction about its longitudinal axis to facilitate a locking or unlocking action of said fin lock.

21. A novelty tool construction, comprising:
a plurality of leg members arranged so that two of said plurality of leg members are in co-alignment and one of said plurality of leg members is offset from the two of said plurality of leg members by an angle θ; and
a tear drop member completely encasing one of the two of said plurality of said leg members and partially encasing the other one of the two of said plurality of said leg members and the offset leg member.

22. The novelty tool construction according to claim 21, wherein said tear drop member has at least two cutout, where one of said cut outs cooperates with said offset leg member to form a first tool, and where the other one of said cut outs cooperates with the two of said plurality of leg members to form a second tool.

23. The novelty tool construction according to claim 22, wherein said first tool is a bottle cap opener and wherein said second tool is an allen wrench.
